(19) United States
(12) Patent Application Publication
(10) Pub. No.: US 2026/0024831 A1
(43) Pub. Date: Jan. 22, 2026

(54) METHOD FOR RECOVERING VALUABLE ELEMENT AND METHOD FOR PRODUCING METAL

(71) Applicant: JFE STEEL CORPORATION, Tokyo (JP)

(72) Inventors: Yuta HINO, Tokyo (JP); Yotaro INOUE, Tokyo (JP); Katsunori TAKAHASHI, Tokyo (JP); Hiroichi SUGIMORI, Imizu-shi (JP); Takeo KASUGA, Imizu-shi (JP)

(73) Assignee: JFE STEEL CORPORATION, Tokyo (JP)

(21) Appl. No.: 18/875,422

(22) PCT Filed: Jul. 19, 2023
(86) PCT No.: PCT/JP2023/026369

§ 371 Date: Dec. 16, 2024

(30) Foreign Application Priority Data
Jul. 28, 2022 (JP) 2022-120866

(51) Int. Cl. H01M 10/54; C22B 5/04; C22B 5/10; C22B 23/02; C22B 26/12; C22B 47/00

(52) U.S. Cl. CPC H01M 10/54; C22B 5/04; C22B 5/10; C22B 23/02; C22B 26/12; C22B 47/00

(57) ABSTRACT

A method recovers a valuable element, by which method Ni and Co can be selectively recovered. In the recovery method, an oxide is reduced by adding a reductant and a flux containing CaO and SiO₂ to the oxide, followed by heating, the oxide containing: at least one element selected from the group made of nickel and cobalt; and manganese. The reductant contains a carbon-containing substance and an iron-containing substance, and the iron-containing substance is at least one selected from the group made of metallic iron and an iron oxide. An addition amount of the carbon-containing substance and the iron-containing substance in total is not less than 1.0 equivalents and not more than 1.5 equivalents.

### TECHNICAL FIELD

The present invention relates to a method for recovering a valuable element and a method for producing metal.

### BACKGROUND ART

In recent years, the demand for lithium ion batteries has been rapidly increasing due to the spread of electric vehicles.

In particular, the demand for electric vehicles with no use of fossil fuels is expected to further expand in the future from the current perspective of suppressing generation of carbon dioxide, and in association with this expectation, the demand for lithium ion batteries is also expected to further increase.

Generally, the cathode material of a lithium ion battery is made from an oxide (composite oxide) containing, for example, nickel (Ni), cobalt (Co) or manganese (Mn). Specific examples of the composite oxide include LiNiO₂, LiCoO₂ and LiMnO₂.

Metal elements such as Ni, Co and Mn are not abundantly available even on a global scale.

Therefore, it is very advantageous to recover those metal elements (valuable elements) from the cathode materials of lithium ion batteries, for the purpose of effective use of resources.

A lithium ion battery is composed of a combination of a cathode material, an anode material, a separator, and other members, and besides contains, for example, an electrolytic solution.

Hence, in order to recover valuable elements from the cathode material of a lithium ion battery, a preliminary process including removal of an electrolytic solution, pulverization, and crushing is performed prior to the recovery.

The cathode material is separated from the lithium ion battery through this preliminary process, and valuable elements are thereafter recovered from the separated cathode material.

The processes of recovering valuable elements are classified into two types, i.e., hydrometallurgical process involving dissolving the cathode material in acid, followed by solvent extraction and electrolytic refining or the like, and pyrometallurgical process involving heating the cathode material together with a reductant and a flux to generate valuable elements by reduction (e.g., Patent Literature 1).

### CITATION LIST

### Patent Literature

Patent Literature 1: JP 2021-95628 A

### SUMMARY OF INVENTION

### Technical Problems

In the pyrometallurgical process, as a result of reducing composite oxides (LiNiO₂, LiCoO₂ and LiMnO₂), aside from metal containing valuable elements (Ni, Co and Mn), slag is formed.

In this process, it may be required to minimize reduction of Mn as much as possible (allow Mn to remain in slag without transitioning it to metal) and selectively transition Ni and Co to metal and recover them.

The present invention has been made in view of the foregoing and aims at providing a method for recovering a valuable element, by which method Ni and Co can be selectively recovered.

### Solution to Problems

The present inventors found, through an earnest study, that employing the configuration described below enables the achievement of the above-mentioned object. The invention has been thus completed.

Specifically, the present invention provides the following [1] to [11].

[1] A method for recovering a valuable element, the method comprising reducing an oxide by adding a reductant and a flux containing CaO and SiO₂ to the oxide, followed by heating, the oxide containing: at least one element selected from the group consisting of nickel and cobalt; and manganese, wherein the reductant contains a carbon-containing substance and an iron-containing substance, and the iron-containing substance is at least one selected from the group consisting of metallic iron and an iron oxide, and an addition amount of the carbon-containing substance and the iron-containing substance in total is not less than 1.0 equivalents and not more than 1.5 equivalents.

[2] The method for recovering a valuable element according to [1], wherein an addition amount of the carbon-containing substance is 1.0 equivalents.

[3] The method for recovering a valuable element according to [1] or [2], wherein the oxide further contains lithium.

[4] The method for recovering a valuable element according to [1] to [3], wherein a content of the manganese in the oxide is not less than 3 mass % and not more than 12 mass %.

[5] The method for recovering a valuable element according to [1] to [4], wherein a mass ratio between CaO and SiO₂ (CaO/SiO₂) contained in the flux is not more than 0.50.

[6] The method for recovering a valuable element according to [1] to [5], wherein a temperature for heating the oxide is not lower than 1,450° C.

[7] The method for recovering a valuable element according to [1] to [6], wherein the iron oxide is ferrous oxide.

[8] The method for recovering a valuable element according to any one of [1] to [7], wherein the iron-containing substance is at least one selected from the group consisting of dust, scale, sludge, and scrap.

[9] The method for recovering a valuable element according to any one of [1] to [8], wherein metal containing iron and at least one element selected from the group consisting of nickel and cobalt is obtained by reducing the oxide.

[10] The method for recovering a valuable element according to any one of [1] to [9], wherein the oxide is obtained from a lithium ion battery.

[11] A method for producing metal containing iron and at least one element selected from the group consisting of nickel and cobalt by using the method for recovering a valuable element according to any one of [1] to [10].

### Advantageous Effects of Invention

The present invention makes it possible to selectively recover Ni and Co.

### BRIEF DESCRIPTION OF THE DRAWINGS

FIG. 1 is a graph showing a result of a reduction experiment 1.

FIG. 2 is a graph showing a result of a reduction experiment 2.

FIG. 3 is an Ellingham diagram (Gibbs standard free energy change-temperature diagram).

### DETAILED DESCRIPTION OF THE INVENTION

### Method for Recovering Valuable Element

The method for recovering a valuable element according to the invention (hereinafter, conveniently referred to as “present recovery method”) includes reducing an oxide by adding a reductant and a flux containing CaO and SiO₂ to the oxide, followed by heating, the oxide containing: at least one element selected from the group consisting of nickel and cobalt; and manganese, the reductant contains a carbon-containing substance and an iron-containing substance, the iron-containing substance is at least one selected from the group consisting of metallic iron and an iron oxide, and an addition amount of the carbon-containing substance and the iron-containing substance in total is not less than 1.0 equivalents and not more than 1.5 equivalents.

Generally, the present recovery method is a method of selectively recovering at least one element (hereinafter, also referred to as “valuable element”) selected from the group consisting of nickel (Ni) and cobalt (Co) from a cathode material (oxide) of a lithium ion battery through the pyrometallurgical process.

### Findings Obtained by Inventors

A general cathode material of a lithium ion battery is made from an oxide (composite oxide) such as LiNiO₂, LiCoO₂, or LiMnO₂.

From a thermodynamic point of view, in the pyrometallurgical process, for example, LiNiO₂ and LiCoO₂ are decomposed at high temperature as expressed below, generating NiO and CoO, respectively.

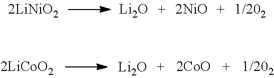

The respective Gibbs standard free energy changes (ΔG⁰) of NiO and CoO in the decomposition reaction are expressed below.

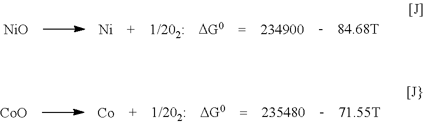

A substance having a value of the free energy change lower than the values of these Gibbs standard free energy changes at any high temperature can be used as the reductant.

When valuable elements are recovered as metal from a composite oxide by the pyrometallurgical process, generally, Mn is inevitably recovered and transitioned to metal.

However, it is apparently difficult to separate Mn that has been transitioned to metal. Therefore, it is desirable to minimize reduction of Mn as much as possible (allow Mn to remain in slag).

Accordingly, the present inventors performed reduction experiments 1 and 2 described below. Consequently, it was found that when a specific reductant is used in a specific addition amount, Ni and Co can be selectively transitioned to metal while Mn is allowed to remain in slag.

In the reduction experiments 1 and 2, an oxide (cathode material of a lithium ion battery), i.e., the reduction target, with a reductant and a flux were added thereto was heated in an argon gas atmosphere at a temperature of 1,650° C., thereby forming metal and slag.

The metal thus formed is called “formed metal,” while the slag thus formed is called “formed slag.”

As the reductant, a carbon-containing substance and an iron-containing substance were used in combination. Specifically, coke (C) was used as the carbon-containing substance, and metallic iron (Fe) was used as the iron-containing substance.

In the reduction experiment 1, the addition amount of Fe was 1.0 equivalents, and the addition amount of C was 0.5 equivalents.

In the reduction experiment 2, the addition amount of C was 1.0 equivalents, and the addition amount of Fe was to 0.5 equivalents.

As described below, an amount of reductant required to reduce the oxide, i.e., NiO and CoO is 1.0 equivalents.

In the reduction experiments 1 and 2, a flux containing calcium oxide (CaO) and silicon dioxide (SiO₂) was used. The flux in an amount of 30 kg was used with respect to 45 kg of the oxide (cathode material).

A reduction ratio (unit: mass %) of each metal element was determined according to the following equation.

$$Reduction ratio = 100 \times ( amount of metal element contained in formed metal [ kg ] ) / ( amount of metal element contained in oxide being reduction target [ kg ] )$$

Further, a residual ratio (unit: mass %) of each metal element in the formed slag was determined according to the following equation.

Residual ratio in formed slag=100×(amount of metal element contained in formed slag [kg])/(amount of metal element contained in oxide being reduction target [kg])

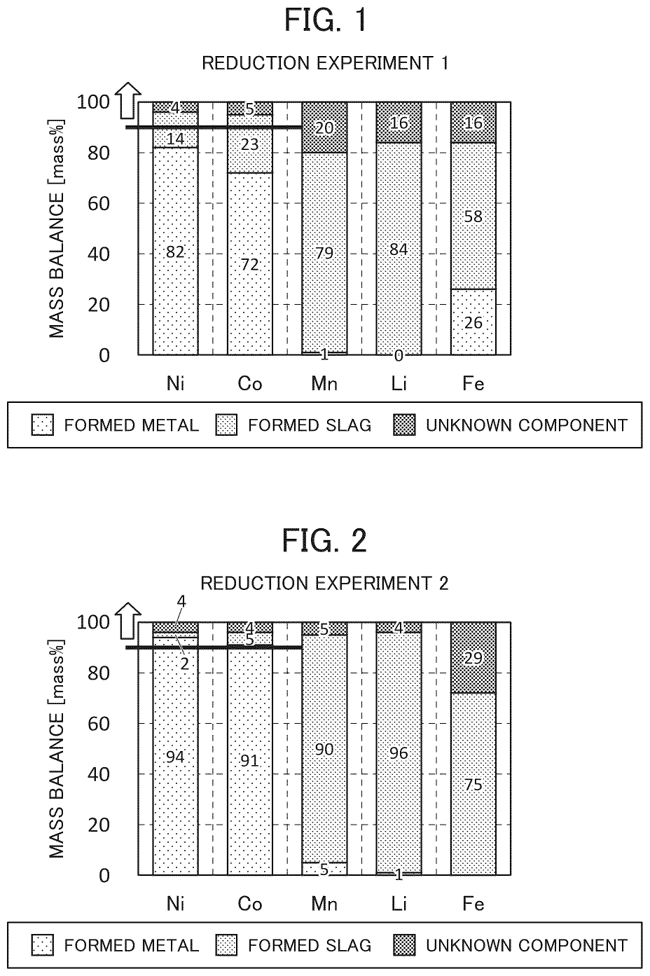

FIG. 1 is a graph showing the result of the reduction experiment 1, and FIG. 2 is a graph showing the result of the reduction experiment 2.

As shown in FIGS. 1 and 2, Ni and Co could achieve high reduction ratios of more than 70 mass % (in particular, Ni achieved more than 80 mass %). In other words, Ni and Co were able to be transitioned to formed metal with high reduction ratios.

In addition, the reduction ratio of Mn was very low (not more than 5 mass %), and a large amount of Mn was thus allowed to remain in the slag.

Further, when the results of the reduction experiments 1 and 2 are compared with each other, in the case where the addition amount of Coke (C) was set to 1.0 equivalents (reduction experiment 2), the higher reduction ratios of Ni and Co were obtained than those in the case where the addition amount of metallic iron (Fe) was set to 1.0 equivalents (reduction experiment 1).

The foregoing results revealed that when the specific reductant in the specific addition amount was used, formed metal containing a small amount of Mn and a large amount of Ni and Co was obtained. In other words, Ni and Co were able to be selectively recovered.

Next, the present recovery method is described below in more detail.

The following description also covers the method for producing metal according to the present invention.

### Reduction Target (Oxide)

The reduction target in the present recovery method is an oxide containing: at least one element selected from the group consisting of nickel (Ni) and cobalt (Co); and manganese (Mn), and specifically is a cathode material of a lithium ion battery, for example.

This oxide may further contain lithium (Li).

A cathode material (oxide) is obtained by performing pretreatment such as removal of an electrolyte on a lithium ion battery.

In view of a compositional range of an oxide (composite oxide) generally used as a cathode material of a lithium ion battery, the Mn content in the oxide is preferably not less than 3 mass % and more preferably not less than 5 mass %.

Similarly, the Mn content in the oxide is preferably not more than 12 mass %, and more preferably not more than 10 mass %.

The Mn content in the oxide is determined through inductively coupled plasma (ICP) emission spectroscopic analysis. The Mn content may be simply determined through X-ray fluorescence (XRF) analysis upon confirmation that the same measurement result as that obtained by inductively coupled plasma (ICP) emission spectroscopic analysis can be obtained.

### Reductant

The reductant used in the present recovery method contains a carbon-containing substance and an iron-containing substance. In other words, the carbon-containing substance and the iron-containing substance are used in combination as the reductant.

With this constitution, as described above, the high reduction ratios of Ni and Co are obtained while the reduction ratio of Mn is reduced. In other words, formed metal containing a small amount of Mn and a large amount of Ni and Co is obtained.

The content (total content) of the carbon-containing substance and the iron-containing substance in the reductant is preferably not less than 90 mass %, more preferably not less than 95 mass %, further preferably not less than 98 mass %, and particularly preferably 100 mass %.

Examples of the carbon-containing substance include a solid carbon-containing substance such as graphite, coke, coal, or solid hydrocarbon; and a gas carbon-containing substance such as carbon monoxide (CO) or hydrocarbon gas (e.g., propane gas).

A carbon-containing substance is preferably used as a reductant because gas such as CO, CO₂ or H₂O is generated after reduction, causing no increase in an amount of formed slag.

An iron-containing substance is at least one selected from the group consisting of metallic iron (Fe) and iron oxide. The iron-containing substance as a reductant is described below in detail.

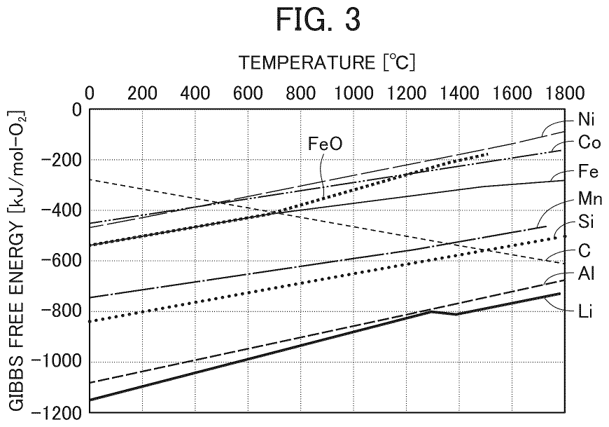

FIG. 3 is an Ellingham diagram (Gibbs standard free energy change-temperature diagram).

Referring to the Gibbs standard free energy changes described above and the Ellingham diagram (FIG. 3), the Fe/FeO equilibrium is negative as compared to the Ni/NiO equilibrium and the Co/CoO equilibrium, and it is thus expected that reduction by use of Fe may be possible.

In addition, the FeO/Fe₃O₄ equilibrium is negative as compared to the Ni/NiO equilibrium but positive as compared to the Co/CoO equilibrium.

Hence, Fe is also expected to selectively reduce Ni and Co (allowing Ni to be incorporated into formed metal and Co to be incorporated into formed slag). Specifically, the following reactions are expected.

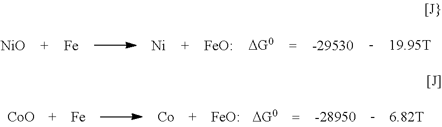

Metalization takes place more easily when the relevant line is situated at a higher position in the Ellingham diagram (FIG. 3).

When Si or Al is used as the reductant, Mn is also easily metalized.

Thus, it can be expected that by the use of Fe (or FeO) as the reductant, only Ni and Co are metalized while Mn is not metalized.

For the metallic iron (Fe), use may be made of, for example, scraps and granular iron used at an iron mill or the like.

In general, iron oxides are classified into three kinds, i.e., ferrous oxide (FeO) which may also be called Wustite, triiron tetraoxide (Fe₃O₄) which may also be called magnetite, and ferric oxide (Fe₂O₃) which may also be called hematite.

Among these, magnetite and hematite have higher Gibbs standard free energy changes than that of Wustite at the same temperature and sometimes have difficulty in causing reduction reaction.

Therefore, among iron oxides, ferrous oxide (Wustite) is preferred because it easily causes reduction reaction.

The iron oxide may be at least one of dust, scale, and sludge (hereinafter, conveniently referred to as “dusts”) that are secondarily produced in an iron making process.

Use of dusts as the iron oxide is preferred in view of effective utilization of by-products from an iron making process and utilization of an inexpensive iron source.

### Addition Amount of Reductant

The addition amount of the carbon-containing substance and the iron-containing substance as the reductant in total is not less than 1.0 equivalents and not more than 1.5 equivalents.

With this constitution, as described above, the high reduction ratios of Ni and Co are obtained while the reduction ratio of Mn is reduced. In other words, formed metal containing a small amount of Mn and a large amount of Ni and Co is obtained.

The total addition amount of the carbon-containing substance and the iron-containing substance is not less than 1.0 equivalents, i.e., stoichiometric composition, preferably not less than 1.2 equivalents, and more preferably not less than 1.3 equivalents.

On the other hand, the total addition amount is preferably not more than 1.4 equivalents.

In calculation of the equivalent of the carbon-containing substance, a fixed carbon content as well as a carbon content and a hydrogen content in a volatiled portion, which are contained in the carbon-containing substance and are components contributing to reduction, are taken into consideration.

For example, when the carbon-containing substance is coke, addition amount of coke×carbon content in coke (unit: mass %) is calculated.

When the carbon-containing substance is propane gas, (addition amount of propane (units: Nm³)/22.4)×(12×3+8) is calculated.

Of the carbon-containing substance and the iron-containing substance used as the reductant, the addition amount of only the carbon-containing substance such as coke (C) is preferably 1.0 equivalents.

With this constitution, as described above, the high reduction ratios of Ni and Co are obtained.

The amount of a reductant required to reduce the reduction target oxide, i.e., NiO or Coo is regarded as 1.0 equivalents.

For instance, in a case where metallic iron (Fe), ferrous oxide (FeO), or coke (C) is used as the reductant, reduction by use of each reductant of 1 equivalent is expressed as follows.

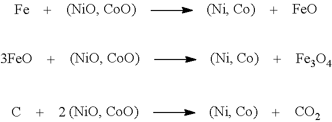

For determining the addition amount of a reductant, first, the NiO and CoO contents in an oxide, i.e., the reduction target are determined.

Specifically, the Ni and Co contents in the reduction target (oxide) are measured and are treated as the Nio and Coo contents in the reduction target (oxide).

The Ni and Co contents are measured using an energy dispersive X-ray spectrometer (EDX).

### Flux

In the present recovery method, a flux containing calcium oxide (CaO) and silicon dioxide (SiO₂) is used.

The content (total content) of CaO and SiO₂ in the flux is preferably not less than 90 mass %, more preferably not less than 95 mass %, further preferably not less than 98 mass %, and particularly preferably 100 mass %.

### Mass Ratio (CaO/SiO₂)

The mass ratio between CaO and SiO₂ (CaO/SiO₂) in the flux is also called basicity.

The mass ratio (CaO/SiO₂) of the flux used in the present recovery method is not particularly limited and is for instance not more than 2.00, preferably not more than 1.80, and more preferably not more than 1.60.

Meanwhile, the flux is preferably made to have low basicity because the reduction ratio of Mn can be further reduced. Specifically, the mass ratio (CaO/SiO₂) of the flux is preferably not more than 1.50, more preferably not more than 1.00, further preferably not more than 0.50, and particularly preferably not more than 0.35.

In addition, when the flux is made to have low basicity as described above, in addition to the formed metal containing Ni and Co, the formed slag containing much Li is obtained. Consequently, lithium can also be recovered easily and efficiently.

The method for further recovering Li from a formed slag is not specifically limited, and examples thereof include various methods such as a method for recovering Li in a form of lithium carbonate by a hydrometallurgical process.

The lower limit of the mass ratio (CaO/SiO₂) of the flux is not particularly limited and is for instance 0.15, preferably 0.20, more preferably 0.25, and further preferably 0.30.

### Mass Ratio {(CaO+Li₂O)/SiO₂}

The flux may further contain lithium oxide (Li₂O) aside from CaO and SiO₂ as the raw material. The flux is preferably prepared in view of the amount of lithium contained in the raw material.

Specifically, {(CaO+Li₂O)/SiO₂} of the flux is preferably not less than 0.05, more preferably not less than 0.10, and further preferably not less than 0.15 because the reduction smelting performance is easily maintained (decrease in a reduction rate is easily suppressed) and because Li₂O is easily fixed to slag (the possibility of recovering Li in the subsequent step is superior).

On the other hand, {(CaO+Li₂O)/SiO₂} of the flux is preferably not more than 2.50, more preferably not more than 2.00, and further preferably not more than 1.50 because increase in slag volume is easily suppressed and because Li₂O is easily fixed to slag.

### Addition Amount of Flux

The amount of a flux added is not particularly limited, and the mass ratio of the flux to the reduction target oxide (flux/oxide) is preferably 0.40 to 1.00, more preferably 0.45 to 0.85, and further preferably 0.50 to 0.80.

### Heating

In the present recovery method, the reductant and the flux are added to an oxide, i.e., the reduction target; in this state, the oxide is heated. Consequently, the oxide is reduced.

The temperature for heating the oxide (heating temperature) is preferably not lower than 1,300° C., more preferably not lower than 1,350° C., further preferably not lower than 1,400° C., and particularly preferably not lower than 1,450° C., because the decrease of reduction is easily suppressed.

The upper limit of the heating temperature is not particularly limited and is appropriately set depending on, for example, the capability of heating equipment (furnace), while a too high heating temperature may cause an excessive cost. Therefore, the heating temperature is preferably not higher than 1,800° C., and more preferably not higher than 1,700° C.

Preferred examples of the atmosphere when the oxide is heated (heating atmosphere) include: an inert atmosphere such as nitrogen gas (N₂) atmosphere, and argon gas (Ar) atmosphere; and a reducing atmosphere such as carbon monoxide gas (CO) atmosphere.

The time for heating the oxide (heating time) is preferably not less than 1 hour, more preferably not less than 2 hours, and further preferably not less than 3 hours, because the decrease of reduction is easily suppressed.

The upper limit of the heating time is not particularly limited. Meanwhile, a too long heating time may cause an excessive cost. Therefore, the heating time is preferably not more than 6 hours, and more preferably not more than 5 hours.

The equipment used for heating the oxide is not particularly limited, and examples thereof include an arc furnace, a submerged arc furnace, a resistance furnace, a high frequency melting furnace, a low frequency melting furnace, a rotary kiln, a vertical furnace, a steelmaking furnace, and other conventionally known equipment.

### Formed Metal

As a result of reducing an oxide, i.e., the reduction target, metal is formed.

In the present recovery method, as described above, metal (formed metal) obtained by reduction of the oxide contains a small amount of Mn and a large amount of Ni and Co. Thus, Ni and Co, which are valuable elements contained in the reduction target oxide, are selectively recovered as the formed metal.

The formed metal may be metal containing only one valuable element among valuable elements Ni and Co (or, may have a higher proportion of one valuable element than that of the other valuable element).

When an iron-containing substance is used as a reductant, the formed metal may further contain iron (Fe).

### Formed Slag

As a result of reducing the oxide, i.e., the reduction target, aside from metal, slag is further formed.

When an iron-containing substance is used as a reductant, the formed slag contains, for example, FeO.

The formed slag may also contain an oxide of a valuable element (such as MnO) that is not included in the formed metal.

In a case where an oxide containing Mn is reduced, the use of iron-containing substance as a reductant makes it possible to suppress incorporation of Mn into the formed metal obtained by the reduction because the Mn/MnO equilibrium is negative as compared to the Fe/FeO equilibrium and the FeO/Fe₃O₄ equilibrium.

When the hydrometallurgical process is performed, its treatment method largely varies depending on the form of Mn, which is troublesome. In the present recovery method adopting the pyrometallurgical process, on the other hand, Mn can be retained in formed slag, advantageously.

### EXAMPLES

The invention is specifically described below with reference to Examples. However, the invention is not limited to the examples described below.

### Cathode Material

First, a cathode material of a lithium ion battery was prepared.

Specifically, the lithium ion battery was subjected to preliminary process including disassembly, electric discharge, and removal of an electrolytic solution, and the cathode material was separated. The cathode material had a composition of Ni:Mn:Co=6:2:2 in molar ratio. The cathode material further contained Li.

The Mn content in the cathode material was 11.3 mass %.

### Reductant

As a reductant, coke (C) powder was prepared.

Further, as reductants, metallic iron (Fe) powder obtained through an atomization process, and ferrous oxide (FeO) powder were prepared.

### Flux

As a flux, a flux comprising CaO and SiO₂ was prepared. Plural types of fluxes having different mass ratios between CaO and SiO₂ (CaO/SiO₂) were prepared.

### Reduction of Cathode Material: Inventive Examples 1 to 4 and Comparative Examples 1 to 5

Next, in a submerged arc furnace with a heat size of 150 kg, the prepared cathode material, the reductant and the flux were charged, and these components were heated by applying current by means of electrodes. At this time, part of the reductant was disposed immediately below the electrodes. The cathode material was thus reduced to obtain formed metal and formed slag. The heating temperature was 1,600° C., the heating time was three hours, and heating atmosphere was Ar atmosphere.

The flux in an amount of 30 kg was added with respect to 45 kg of the cathode material. In other words, the mass ratio of the flux to the cathode material (flux/cathode material) was set to about 0.67.

The type of reductant used, the addition amount (unit: equivalent) of the reductant, and the mass ratio (CaO/SiO₂) of the flux used are shown in Table 1 below.

In addition, the reduction ratios of the respective metal elements, i.e., Ni, Co, and Mn were determined based on the above-described equation. The unit of the determined reduction ratio was converted from “mass %” to “mol %.”

Further, for Li, the residual ratio in the formed slag is determined according the above-described equation. The unit of the determined residual ratio in the formed slag was converted from “mass %” to “mol %.”

The results are shown in Table 1 below.

TABLE 1

| | Reductant | | | | Flux | | Reduction | | | Residual ratio |
|---|---|---|---|---|---|---|---|---|---|---|
| | Addition amount | | | | | Mass ratio | ratio | | | (Li) in |
| | [equivalent] | | | | Mass ratio | [(CaO + Li₂O)/ | [mol %] | | | formed slag |
| | Whole | Fe | FeO | C | (CaO/SiO₂) | SiO₂] | Ni | Co | Mn | [mol %] |
| Inventive | 1.4 | 1.0 | 0 | 0.4 | 1.50 | 2.20 | 85 | 76 | 1 | 84 |
| Example 1 | | | | | | | | | | |
| Inventive | 1.4 | 0.4 | 0 | 1.0 | 1.50 | 2.12 | 94 | 91 | 5 | 96 |
| Example 2 | | | | | | | | | | |
| Inventive | 1.4 | 0.4 | 0 | 1.0 | 0.50 | 0.92 | 89 | 86 | 1 | 100 |
| Example 3 | | | | | | | | | | |
| Inventive | 1.4 | 0 | 0.4 | 1.0 | 0.50 | 0.89 | 89 | 84 | 1 | 100 |
| Example 4 | | | | | | | | | | |
| Inventive | 1.4 | 0.4 | 0 | 1.0 | 0.35 | 0.57 | 87 | 82 | 0.5 | 100 |
| Example 5 | | | | | | | | | | |
| Inventive | 1.4 | 0 | 0.4 | 1.0 | 0.17 | 0.26 | 86 | 80 | 0.3 | 100 |
| Example 6 | | | | | | | | | | |
| Comparative | 1.4 | 0 | 0 | 1.4 | 1.50 | 2.05 | 96 | 95 | 51 | 61 |
| Example 1 | | | | | | | | | | |
| Comparative | 1.4 | 0 | 0 | 1.4 | 0.50 | 0.90 | 98 | 95 | 20 | 100 |
| Example 2 | | | | | | | | | | |
| Comparative | 1.4 | 1.4 | 0 | 0 | 1.50 | 2.00 | 81 | 69 | 3.8 | 84 |
| Example 3 | | | | | | | | | | |
| Comparative | 1.4 | 1.4 | 0 | 0 | 0.50 | 0.86 | 80 | 67 | 3.5 | 86 |
| Example 4 | | | | | | | | | | |
| Comparative | 1.4 | 0 | 1.4 | 0 | 0.50 | 0.82 | 79 | 66 | 1.8 | 96 |
| Example 5 | | | | | | | | | | |

### Summary of Evaluation Results

As shown in Table 1 above, Comparative Examples 1 and 2 in which only coke (C) was used as the reductant had high reduction ratios of Mn.

In Comparative Examples 3 to 5 in which only metallic iron (Fe) or ferrous oxide (FeO) was used as the reductant, the reduction of Mn was suppressed, but the reduction of each of Ni and Co was insufficient.

On the other hand, in Inventive Examples 1 to 6 in which metallic iron (Fe) or ferrous oxide (FeO) and coke (C) were used in combination as the reductant, higher reduction ratios for Ni and Co were obtained while the reduction of Mn was suppressed. In other words, Ni and Co were able to be selectively recovered.

When Inventive Example 1 and Inventive Example 2 are compared with each other, in Inventive Example 2 in which the addition amount of coke (C) as the carbon-containing substance was 1.0 equivalents, the higher reduction ratios for Ni and Co than those in Inventive Example 1 in which the addition amount was 0.4 equivalents were obtained.

When Inventive Example 2 is compared with Inventive Examples 3 and 4, in Inventive Examples 3 and 4 in which the flux having a mass ratio (CaO/SiO₂) of 0.50 was used, the reduction of Mn was able to be well suppressed as compared with Inventive Example 2 in which the flux having a mass ratio (CaO/SiO₂) of 1.50 was used. In addition, the higher residual ratio of Li in the formed slag was able to be achieved.

When Inventive Examples 3 and 4 are compared with Inventive Examples 5 and 6, in Inventive Examples 5 and 6 in which the mass ratio (CaO/SiO₂) of the flux was further lowered, the reduction of Mn was able to be further suppressed without causing large decrease in reduction ratios of Ni and Co as compared with Inventive Examples 3 and 4.

1. A method for recovering a valuable element, the method comprising reducing an oxide by adding a reductant and a flux containing CaO and SiO₂ to the oxide, followed by heating,
the oxide containing: at least one element selected from the group consisting of nickel and cobalt; and manganese,
wherein the reductant contains a carbon-containing substance and an iron-containing substance, and the iron-containing substance is at least one selected from the group consisting of metallic iron and an iron oxide, and
an addition amount of the carbon-containing substance and the iron-containing substance in total is not less than 1.0 equivalents and not more than 1.5 equivalents.

2. The method for recovering a valuable element according to claim 1, wherein an addition amount of the carbon-containing substance is 1.0 equivalents.

3. The method for recovering a valuable element according to claim 1, wherein the oxide further contains lithium.

4. The method for recovering a valuable element according to claim 1, wherein a content of the manganese in the oxide is not less than 3 mass % and not more than 12 mass %.

5. The method for recovering a valuable element according to claim 1, wherein a mass ratio between CaO and SiO₂ (CaO/SiO₂) contained in the flux is not more than 0.50.

6. The method for recovering a valuable element according to claim 1, wherein a temperature for heating the oxide is not lower than 1,450° C.

7. The method for recovering a valuable element according to claim 1, wherein the iron oxide is ferrous oxide.

8. The method for recovering a valuable element according to claim 1, wherein the iron-containing substance is at least one selected from the group consisting of dust, scale, sludge, and scrap.

9. The method for recovering a valuable element according to claim 1, wherein metal containing iron and at least one element selected from the group consisting of nickel and cobalt is obtained by reducing the oxide.

10. The method for recovering a valuable element according to claim 1, wherein the oxide is obtained from a lithium ion battery.

11. A method for producing metal containing iron and at least one element selected from the group consisting of nickel and cobalt by using the method for recovering a valuable element according to claim 1.

12. The method for recovering a valuable element according to claim 3, wherein a content of the manganese in the oxide is not less than 3 mass % and not more than 12 mass %.

13. The method for recovering a valuable element according to claim 3, wherein a mass ratio between CaO and SiO₂ (CaO/SiO₂) contained in the flux is not more than 0.50.

14. The method for recovering a valuable element according to claim 3, wherein a temperature for heating the oxide is not lower than 1,450° C.

15. The method for recovering a valuable element according to claim 3, wherein the iron oxide is ferrous oxide.

16. The method for recovering a valuable element according to claim 3, wherein the iron-containing substance is at least one selected from the group consisting of dust, scale, sludge, and scrap.

17. The method for recovering a valuable element according to claim 3, wherein metal containing iron and at least one element selected from the group consisting of nickel and cobalt is obtained by reducing the oxide.

18. The method for recovering a valuable element according to claim 3, wherein the oxide is obtained from a lithium ion battery.

19. A method for producing metal containing iron and at least one element selected from the group consisting of nickel and cobalt by using the method for recovering a valuable element according to claim 3.
